(19) United States
(12) Patent Application Publication
(10) Pub. No.: US 2013/0018759 A1
(43) Pub. Date: Jan. 17, 2013

(54) THIRD PARTY TOKEN SYSTEM FOR ANONYMOUS SHIPPING

(71) Applicants: Max E. Metral, Bookline, MA (US); Raghuram Gururajan, San Jose, CA (US)

(72) Inventors: Max E. Metral, Bookline, MA (US); Raghuram Gururajan, San Jose, CA (US)

(73) Assignee: eBay Inc., San Jose, CA (US)

(21) Appl. No.: 13/436,496

(22) Filed: Mar. 30, 2012

Related U.S. Application Data
(63) Continuation-in-part of application No. 13/182,238, filed on Jul. 13, 2011.

(51) Int. Cl. G06Q 50/28; G06Q 30/00

(52) U.S. Cl. 705/26.41; 705/334

(57) ABSTRACT

A method and a system for a third party token system for anonymous shipping are described. A selection of shipping service providers approved by a recipient is received. A token corresponding to a mailing address of the recipient is generated. The token corresponding to the mailing address of the recipient is sent to a shipping service provider approved by the recipient. The token is valid only for the shipping service providers selected by the recipient.

### RELATED APPLICATION

This application is a continuation-in-part of U.S. patent application Ser. No. 13/182,238, filed Jul. 13, 2011, entitled “Universal Addressing Scheme.”

### TECHNICAL FIELD

This application relates generally to the field of computer technology, and in a specific example embodiment, a third party token system for anonymous shipping.

### BACKGROUND

Every time a sender mails a package to a recipient, the sender must carefully write the physical address of the sender and the recipient. The physical address includes zip code and city. The sender needs to be careful not to make any mistakes so as to avoid any shipping delays.

When mailing a package, the mailing label affixed to the package typically includes the address of the sender, the address of the recipient, and a postage stamp to indicate that a payment has been made for the cost of transport from the sender to the recipient. The address of the recipient is read from the mailing label to determine where to deliver the package. The address of the sender may be read by the recipient to identify a source of the package and/or by a shipping processor to determine to whom an undeliverable package should be returned.

In another scenario, a recipient may not wish to share his or her mailing address with the sender.

### BRIEF DESCRIPTION OF THE DRAWINGS

The present invention is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2A is a block diagram illustrating an example embodiment of a universal addressing application;

FIG. 2B is a block diagram illustrating an example embodiment of a shipping token application;

FIG. 3 is a block diagram illustrating an example embodiment of using the universal addressing application to ship an item;

FIG. 4 is a block diagram illustrating another example embodiment of a process for using the universal addressing application to notify third parties of a new physical address;

FIG. 5 is a block diagram illustrating another example embodiment of a process for using the universal addressing application to validate a physical address of a user;

FIG. 6 is a flow chart of one embodiment of a method for validating a physical address and operating a financial transaction based on an email address;

FIG. 7 is a flow chart of one embodiment of a method for validating a physical address based on an email address;

FIG. 8 is a flow chart of one embodiment of a method for operating a financial transaction based on an email address;

FIG. 9 is a flow chart of one embodiment of a method for setting up a generic token system;

FIG. 10 is a flow chart of one embodiment of a method for operating a generic token system; and

FIG. 11 shows a diagrammatic representation of machine in the example form of a computer system within which a set of instructions may be executed to cause the machine to perform any one or more of the methodologies discussed herein.

### DETAILED DESCRIPTION

Although the embodiments of the invention have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In an online marketplace, a buyer or recipient may be reluctant to provide personal information such as his mailing address to a seller. A token associated with the mailing address of the buyer may be provided to the seller. The seller may then use token to ship an item to the buyer with a shipping service provider who has privileged access the actual mailing address information of the buyer. However, the buyer may wish to further limit the scope of which shipping service provider may be privileged to access the actual mailing address information of the buyer. This description illustrates how a token is generated to provide anonymity for shipping while allowing the buyer or recipient to control the scope of who can use the token for shipping.

In various embodiments, a method and a system for a third party token system for anonymous shipping are described. A selection of shipping service providers approved by a recipient is received. A token corresponding to a mailing address of the recipient is generated. The token corresponding to the mailing address of the recipient is sent to a shipping service provider approved by the recipient. The token is valid only for the shipping service providers selected by the recipient.

Furthermore, every time a user needs to submit to a verification of his/her residence/physical address to a third party, there is no centralized service currently to verify the current physical address of the user online and to generate a report. For example, a user ordering an item on a website may be asked for his or her residence address. In another example, a user who wishes to send an item to another user is required to enter the physical addresses of the respective parties on a shipping service website. In yet, another example, a user who wishes to apply for a loan or a credit card may be required to enter his physical residence address. Those of ordinary skill in the art will recognize that many online services require the physical address of a user in order to perform a transaction. This description illustrates how a financial institution (e.g., such as Paypal) can be used as a service to verify the address of any user registered with the financial institution. Thus, a financial institution can act as an online gateway for third party systems to check and verify any user identity.

Every time a credit report is generated by a third party system, either online or through a physical form, a user has to provide his social security number and he has to make sure his identity is not compromised. This description illustrates how a user registered with an entity offering a universal addressing service, consistent with embodiments of the invention, can provide his email address or ID alone for generating credit report. The backend gateway systems of the universal addressing service take care of interacting with credit bureaus and generating credit reports. Thus, the user's identity is concealed and safe.

In various embodiments, a method and a system for a universal addressing scheme are also described. A physical address validation module retrieves and validates a physical address associated with an e-mail address received from a third party server. A financial transaction validation module retrieves a financial account associated with the e-mail address and operates a financial transaction on the financial account. A third party authentication module authenticates the third-party server prior to communicating the physical address and operating the financial transaction to the third-party server. The physical address may consist of, for example, the street name and number, the city, and the state of a person, company, or other relevant entity. In another embodiment, the physical address may include a Post Office Box at a Post Office or other private mailing services. As such, the universal addressing server allows for a user to use their email address instead of their physical address.

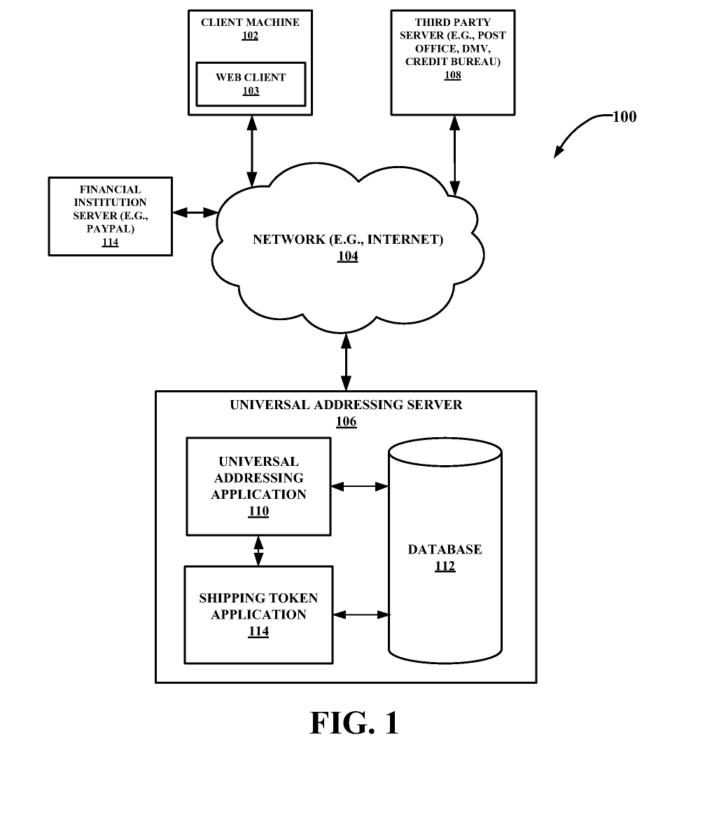

FIG. 1 illustrates an example system 100 in which a client machine 102 may be in communication with a universal addressing server 106 and/or a third party server 108 over a network 104. A user operating the client machine 102 may communicate with the universal addressing provider 106 and/or the third party server 108 to enable utilization of services provided by the third party server 108. The user may use a web client 103 or a programmatic client to communicate with the universal addressing server 106. For example, the third party server 108 may include a shipping service where the user is requesting an item to be sent, delivered, or mailed. The item may be a post card, a letter, a telegram, a package, overnight mail, or another item sent by or through the postal office or a shipping company. In another example, the third party server 108 may include a credit bureau server. The user operating the client machine 102 wishes to update his physical address on his credit report. In another example, the third party server 108 may include a public agency (e.g., a Department of Motor Vehicles, or DMV) or a private agency (e.g., a Credit Bureau) that requires verification of the physical address of the user operating the client machine 102.

Examples of the client machine 102 include a mail scanning device, a set-top box (STB), a receiver card, a mobile telephone, a personal digital assistant (PDA), a display device, a portable gaming unit, and a computing system; however other devices may also be used.

The network 104 over which the client machine 102, the universal addressing server 106 and/or the third party server 108 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The universal addressing server 106 may be used to verify information provided by the third party server 108. A resulting confirmation of verification may be provided by the universal addressing server 106 to the client machine 102 and/or the third party server 108.

In one example, the third party server 108 may be used to process a postal item for shipping. The third party server 108 may be operated by or on behalf of a shipping company to enable sending and receiving of postal items. The verification of data on the postal item may be performed on the universal addressing server 106.

The universal addressing server 106 may include a universal addressing application 110, a shipping token application 116, and a database 112. The universal addressing application 110 validates the email address and physical address of the user. The shipping token application 116 generates tokens used for shipping anonymously. The database 112 stores user data which may include information regarding information of senders, recipients, token information, approved shipping service providers, users of the third party server 108 and/or a financial institution server 114.

The universal addressing server 106 may be in communication with the financial institution server 114 associated with an email address of the user at the client machine 102. As such, the universal addressing application 110 can also perform financial transactions on a financial account of the user at the financial institution server 114. This assumes that the user has previously set up a financial account with the financial institution server 114 using the same email address.

The universal addressing application 110 and shipping token application 116 may be deployed in the client machine 102, the universal addressing server 106, and/or the third party server 108 to verify that a user is associated with a source user data and process the postal item for delivery based on verification of the user and/or provide a confirmation of verification. For example, the universal addressing application 110 may provide a confirmation of verification to the client machine 102 and/or the universal addressing server 106, and/or the third party server 108. The third party server 108 may process the postal or shipping item for delivery after verifying the user or receiving a confirmation of verification from the universal addressing application 110. In another embodiment, the third party server 108 includes a server of a shipping service provider.

The financial institution server 114 may receive a payment request and provide confirmation of payment to the client machine 102, the universal addressing server 106, and/or the third party server 108. The financial institution server 114 may also be capable of receiving and providing payments. The financial institution server 114 may be, by way of example, PayPal of San Jose, Calif. However, other payment providers may also be used.

In one embodiment, the financial institution server 114 comprises a storage device configured to store the name of a user, a corresponding e-mail address, a corresponding physical address, and a corresponding financial account.

In another embodiment, the client device 102 and the third party server 108 may include a universal addressing application program interface (API) (not shown) that communicates with the universal addressing application 110 of universal addressing server 106. The client device 102 and the third party server 108 may include a shipping token application interface (API) (not shown) that communicates with the shipping token application 116 of universal addressing server 106. The API may be implemented in any other devices.

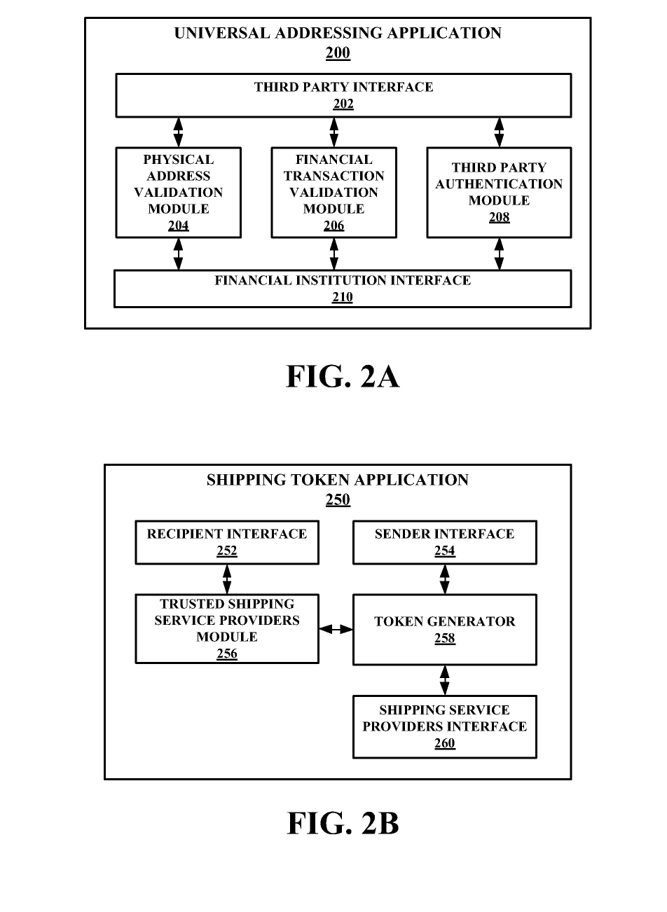

FIG. 2A is a block diagram illustrating an example embodiment of a universal addressing application 200. The universal addressing application 200 includes, for example, a third party server interface 202, a physical address validation module 204, a financial transaction validation module 206, a third-party authorization module 208, and a financial institution interface 210. The third party interface 202 is configured to communicate with a third-party server, such as the third-party server 108 of FIG. 1. The financial institution interface 210 is configured to communicate with a financial institution server, such as the financial institution server 114 of FIG. 1.

The physical address validation module 204 retrieves a physical address associated with an e-mail address received from the third party server 108. For example, the third party server 108 receives a request from a user at the client device 102 to perform an operation. The operation includes, for example, a request to ship an item from the user, a request to validate a physical address of the user, or a request to update a physical address of the user. The user at the client device 102 supplies the e-mail address of the user to the third-party server 108 to perform the operation. In order to perform the operation, the third-party server 108 needs to retrieve the physical address corresponding to the e-mail address of the user. As such, the third party server 108 supplies the e-mail address of the user to the physical address validation module 204 of the universal addressing application, via the third party interface 202. The physical address validation module 204 communicates with the financial institution server 114 via the financial institution interface 210 to retrieve the physical address of the corresponding e-mail address provided by the third-party server 108. Upon receiving the physical address information, the physical address validation module 204 returns the physical address information to the third-party server 108 via the third-party interface 202.

In another example, the third-party server 108 receives a request from the user at client device 102 to perform a financial transaction associated with the operation. For example, the financial transaction may include paying a transaction amount for the operation to the third-party server 108. In other words, the user is requesting the third-party server 108 to withdraw a specified amount from a bank account of a financial institution associated with the user.

In this case, the third-party server 108 receives the e-mail address of the user along with a specified transaction amount for the operation. The third-party server 108 communicates with the financial transaction validation module 206 to perform a financial transaction in the specified transaction amount on a bank account of the user. The financial transaction validation module 206 receives the e-mail address of the user and the specified transaction amount, via the third party interface 202. The financial transaction validation module 206 communicates with the financial institution server 114 via the financial institution interface 210. The financial transaction validation module 206 sends a request to the financial institution server 114 to perform a financial transaction in the specified transaction amount on the bank account associated with the e-mail address of the user. Upon receipt of the confirmation of the completed financial transaction, the financial transaction validation module 206 forwards the confirmation to the third-party server 108.

In another embodiment, the financial transaction validation module 206 retrieves a financial account associated with the e-mail address of the user and operates a financial transaction on the financial account associated with the email address of the user.

The third party authentication module 208 authenticates the third-party server 108 prior to operating the financial transaction. For example, the universal addressing application 106 needs to verify that the request from the third-party server 108 is a legitimate request from the user at the client device 102. In one embodiment, the third-party server 108 has already established an authenticated communication with the universal addressing server 106 through an exchange of public keys. Those of ordinary skill in the art will recognize that other methods of authentication may be used to authenticate the communication between the third-party server 108 and the universal addressing server 106.

In another embodiment, the universal addressing server 106 requests a confirmation of the financial transaction directly from the user at client device 102. For example, the universal addressing server 106 may send a text message or an e-mail to the user of the requested financial transaction from the third-party server 108.

FIG. 2B is a block diagram illustrating an example embodiment of a shipping token application 250. The shipping token application 250 includes a recipient interface 252, a sender interface 254, a trusted shipping service provider module 256, a token generator 258, and a shipping service providers interface 260.

The recipient interface 252 is configured to communicate with a client machine of a recipient. The recipient may be, for example, a buyer who has placed an order for an item on an electronic marketplace to a seller.

The sender interface 254 is configured to communicate with a client machine of a sender. The sender may be, for example, a seller who has received an order for an item on an electronic marketplace from a buyer.

The shipping service providers interface 260 is configured to communicate with one or more different shipping carrier servers. The shipping service provider may be, for example, Fedex, UPS, DHL, USPS and others.

The trusted shipping service provider module 256 receives a selection of one or more shipping service providers approved by a recipient. In one embodiment, the trusted shipping service provider module 256 generates a list of shipping service providers to a buyer or recipient. The buyer or recipient can then select and approve individual shipping service providers that the buyer trusts or is comfortable with.

The token generator 258 generates one or more tokens corresponding to a mailing address of the recipient. For example, the token may include an alphanumeric code that identifies the recipient but keep the mailing address of the recipient anonymous to the sender. The alphanumeric code may correspond to an identity of the recipient, the mailing address of the recipient, and a selected shipping service provider.

The token only can be deciphered with a shipping service provider approved by the recipient. In other words, the one or more tokens are valid only for the one or more shipping service providers selected and approved by the recipient.

In one embodiment, the token generator 258 communicates the one or more tokens with the corresponding mailing address of the recipient to the selected shipping service providers with the shipping service provider interface 260.

In one embodiment, the token generator 258 may receive a request from a sender for a token associated with the recipient. The token generator 258 then communicates the one or more tokens corresponding to the mailing address of the recipient to the sender in response to the request.

In another embodiment, the token generator 258 identifies at least one of the selected shipping service providers to the sender. The token generator 258 then communicates to the sender that the one or more tokens are valid only with respect to the at least one of the selected shipping service providers.

In another embodiment, the token generator 258 receives a query from a sender to confirm whether a shipping service provider has been approved by the recipient. The token generator 258 then communicates to the sender whether the shipping service provider has been approved by the recipient.

In another embodiment, the token generator 258 receives a request from a sender for a token associated with the recipient and an identification of a shipping service provider. The token generator 258 then determines whether the shipping service provider identified by the sender has been approved by the recipient. The token generator 258 communicates a token associated with the identified shipping service provider to the sender if it has been determined that the service provider identified by the sender has been approved by the recipient.

In one embodiment, a storage device comprising the database 112 stores information of the sender, information of the recipient, a mailing address of the recipient, selected shipping service providers approved by the recipient, and the one or more tokens corresponding to the selected shipping service providers.

In other embodiments, the token generator 258 associates the one or more tokens with the sender. The token generator 258 may also generate a disposable token for a single use. The token generator 258 generates the one or more token for a sender to apply the one or more token on a shipping package in lieu of a mailing address of the recipient.

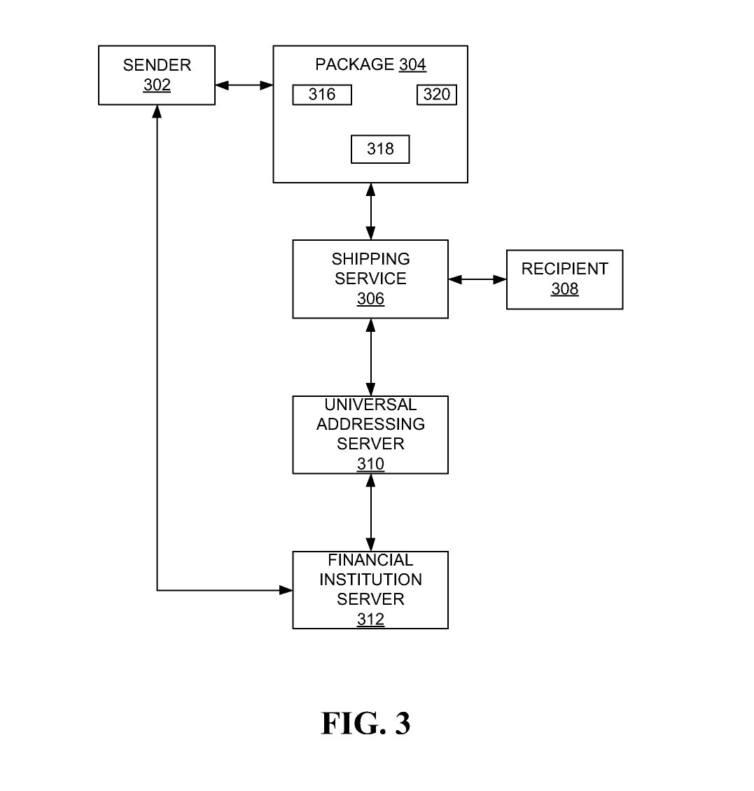

FIG. 3 is a block diagram illustrating an example embodiment of using the universal addressing server 106 to ship an item. A sender 302 wishes to send a package 304 to a recipient 308. The package 304 may be labeled with a sender e-mail address 316, a recipient e-mail address 318, and a postage e-mail address 320. The sender e-mail address 316 includes one or more e-mail addresses of the sender 302. The recipient e-mail address 318 includes one or more e-mail addresses of the recipient 308. The postage e-mail address 320 includes one or more e-mail addresses of the party responsible for the shipping cost of the package 304. The sender 302 provides the package 304 to the shipping service 306. The shipping service 306 may include for example a shipping company.

In another embodiment, the e-mail addresses may include the username and the domain name. In another embodiment, the e-mail addresses include a unique identifier or username without the domain name.

The shipping service 306 determines the physical address corresponding to the sender e-mail address 316 and the recipient e-mail address 318 from the label on the package 304. In one embodiment, the shipping service 306 submits the sender e-mail address 316 and the recipient e-mail address 318 to the universal addressing server 310. The universal addressing server 310 communicates with a financial institution server 312 to retrieve the physical address corresponding to the sender and recipient e-mail addresses. The universal addressing server 310 returns the physical addresses of the sender and of the recipient to the shipping service 306.

The shipping service 306 calculates a postage amount based on the physical addresses of the recipient and of the sender. The shipping service 306 then submits a request for a financial transaction in the amount of the determined postage amount on a financial account associated with the postage e-mail address 320. In one embodiment, the postage e-mail address 320 may include the sender e-mail address 316, the recipient e-mail address 318, or any other e-mail address associated with the payment of shipping the package 304.

The universal addressing server 310 communicates with the financial institution server 312 to retrieve and operate on the financial account associated with the postage e-mail address 320. A confirmation of the financial transaction may be returned to the shipping service 306. Upon receipt of the confirmation of the financial transaction, the shipping service 306 proceeds with shipping the package 304 to the recipient 308.

In another embodiment, the financial institution server 312 may communicate with another financial institution to perform a financial transaction in the amount of the determined postage.

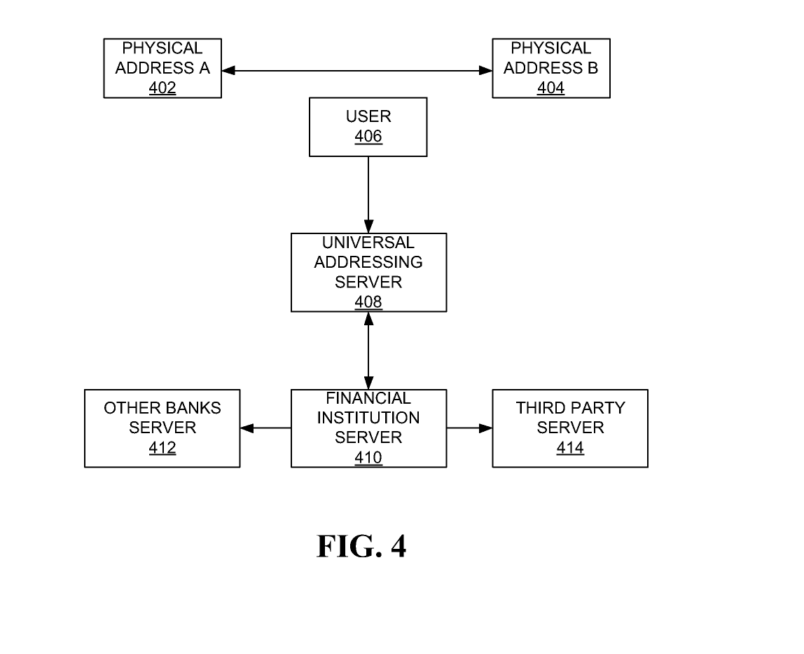

FIG. 4 is a block diagram illustrating another example embodiment of a process for using the universal addressing application to notify third parties of a new physical address of a user. In this example, a user 406 has moved his/her residence address from a physical address A 402 to a new physical address B 404. The user 406 notifies a universal addressing server 408 of his or her new physical address B 404. The universal addressing server 408 updates its database to associate the user's e-mail address with the new physical address 404.

Furthermore, the universal addressing server 408 is capable of notifying a financial institution server 410 of the updated new physical address 404 associated with the e-mail address of the user. In one embodiment the financial institution server 410 includes a database of the user's e-mail address, a corresponding physical address, and a corresponding financial account.

The financial institution server 410 can further notify all other parties of the new physical address of the user. For example, the financial institution server 410 notifies a bank server 412 of the updated new physical address 404 of the user. In another example, the financial institution server 410 notifies a third-party server 414 of the updated new physical address 404 of the user. The third-party server 414 may include for example a Credit Bureau, a motor vehicle registration office, a small business registered with the financial institution server 410, and so forth.

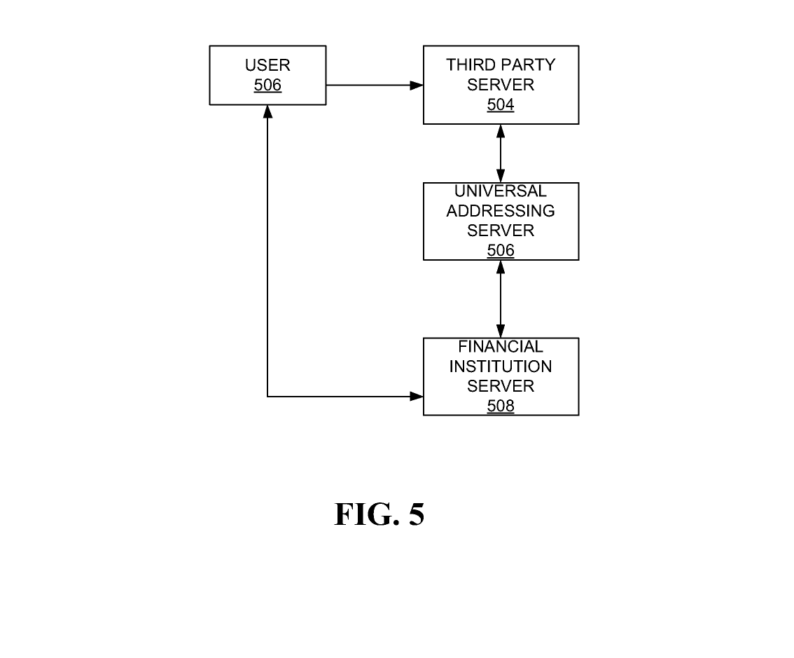

FIG. 5 is a block diagram illustrating another example embodiment of a process for using the universal addressing application to validate a physical address of a user. A user 502 sends to a third-party 504 his or her e-mail address along with an authorization to validate and verify his or her physical address based on the submitted e-mail address. For example, the third-party 504 may be a landlord, a car dealer, a small business, and so forth.

The third-party 504 submits the e-mail address of the user 502 along with the authorization to the universal addressing server 506. The universal addressing server 506 communicates with a financial institution server 508 to retrieve the financial information of the user and the physical address of the user based on the submitted e-mail address.

For example, a user may provide his or her e-mail address on a rental form application to a landlord. The landlord submits the e-mail address of the user from the filled out rental form application to the universal addressing server 506 to retrieve a recent history of physical addresses of the user along with financial information of the user. The financial information may include, for example, a balance on a user's financial account, a credit history, or a credit rating of the user.

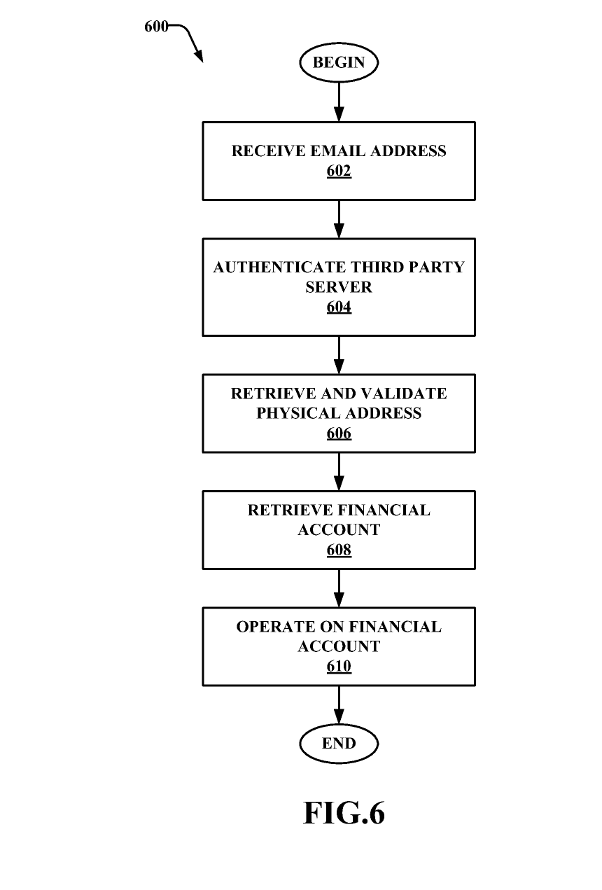

FIG. 6 is a flow chart of one embodiment of a method for validating a physical address and operating a financial transaction based on an email address. At 602, a universal addressing application receives an e-mail address of a user. At 604, the universal addressing application authenticates the third party server that has submitted the e-mail address of the user. At 608, the universal addressing application retrieves and validates a physical address associated with the e-mail address of the user received from a third-party server. At 610, the universal addressing application retrieves a financial account associated with the e-mail address and operates a financial transaction on the financial account.

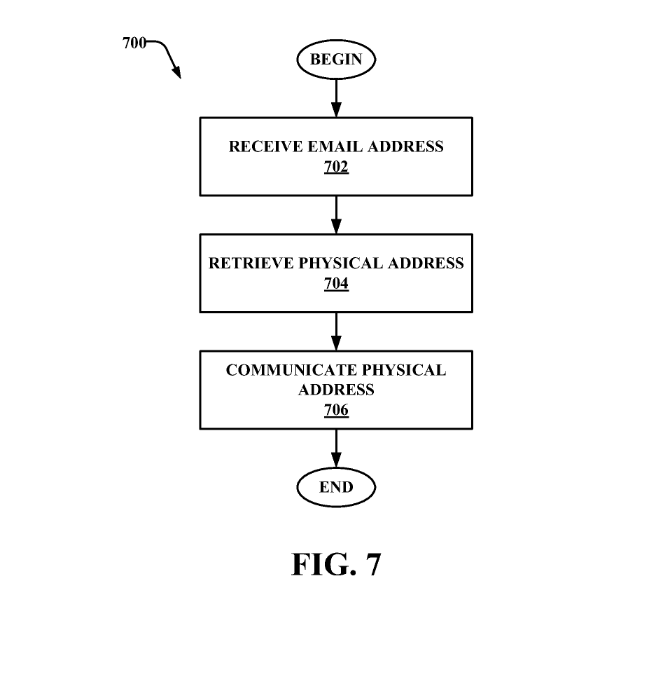

FIG. 7 is a flow chart of one embodiment of a method for validating a physical address based on an email address. At 702, a universal addressing application receives the e-mail address from a third-party server. At 704, the universal addressing application retrieves the physical address associated with the e-mail address. At 706, the universal addressing application communicates the physical address associated with the e-mail address to the third-party server in response to receiving the e-mail address from the third-party server.

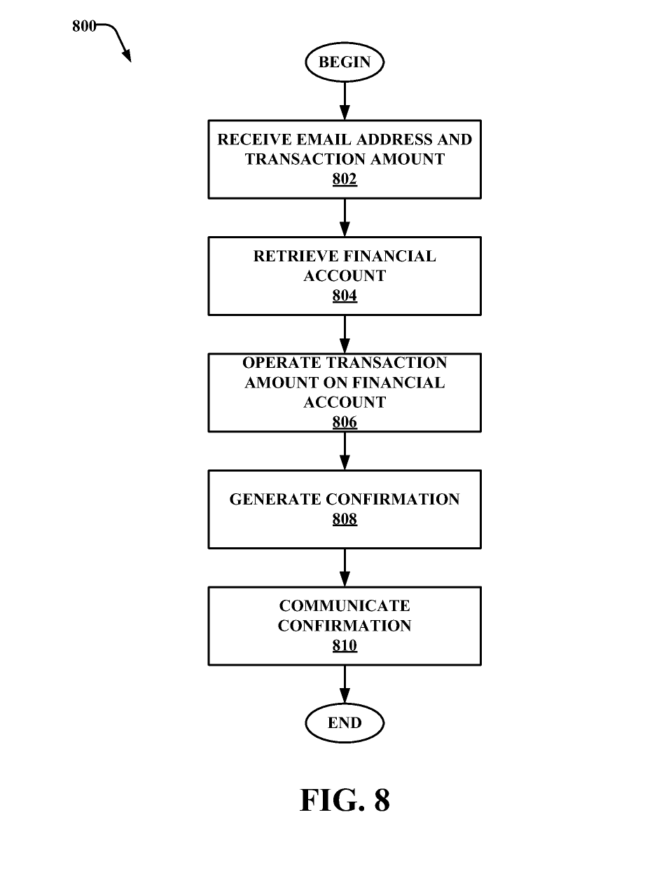

FIG. 8 is a flow chart of one embodiment of a method for operating a financial transaction based on an email address. At 802, the universal addressing application receives the e-mail address and a transaction amount from a third-party server. In another embodiment, the universal addressing application also receives an authorization for the transaction amount from the third-party server. At 804, the universal addressing application retrieves the financial account associated with the e-mail address. At 806, the universal addressing application operates the transaction amount on the financial account associated with the e-mail address. At 808 a confirmation of the transaction amount is generated and communicated to the third-party server at 810.

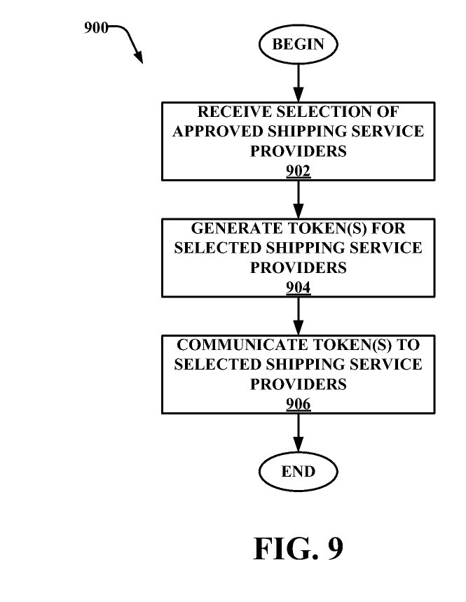

FIG. 9 is a flow chart 900 of one embodiment of a method for setting up a generic token system. At operation 902, a selection of one or more shipping service providers approved by a recipient is received. At operation 904, one or more tokens corresponding to a mailing address of the recipient is generated. The one or more tokens are valid only for the selected one or more shipping service providers. At operation 906, the one or more tokens with the corresponding mailing address of the recipient are communicated to the selected shipping service providers.

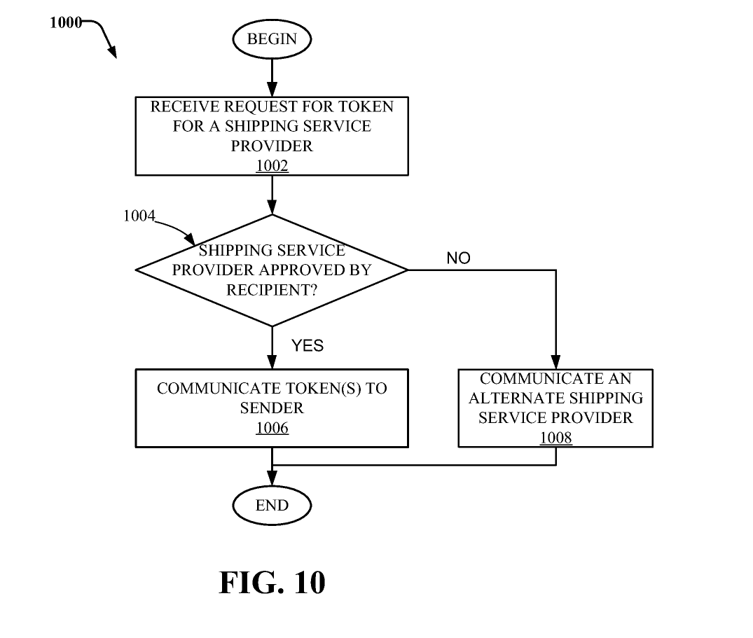

FIG. 10 is a flow chart 1000 of one embodiment of a method for operating a generic token system. At operation 1002, a request for a token for a shipping service provider is received from a sender. At operation 1004, the token generator determines whether the identified shipping service provider has been approved by the recipient. If the identified shipping service provider has been previously approved by the recipient, the token corresponding to the approved shipping service provider is communicated to the sender at operation 1006.

If the identified shipping service provider has not been previously approved by the recipient, the token generator may suggest alternative shipping service providers that have been approved by the recipient at operation 1008. In another embodiment, the token generator may plainly reject the token request and request the sender to resubmit the request identifying another shipping service provider.

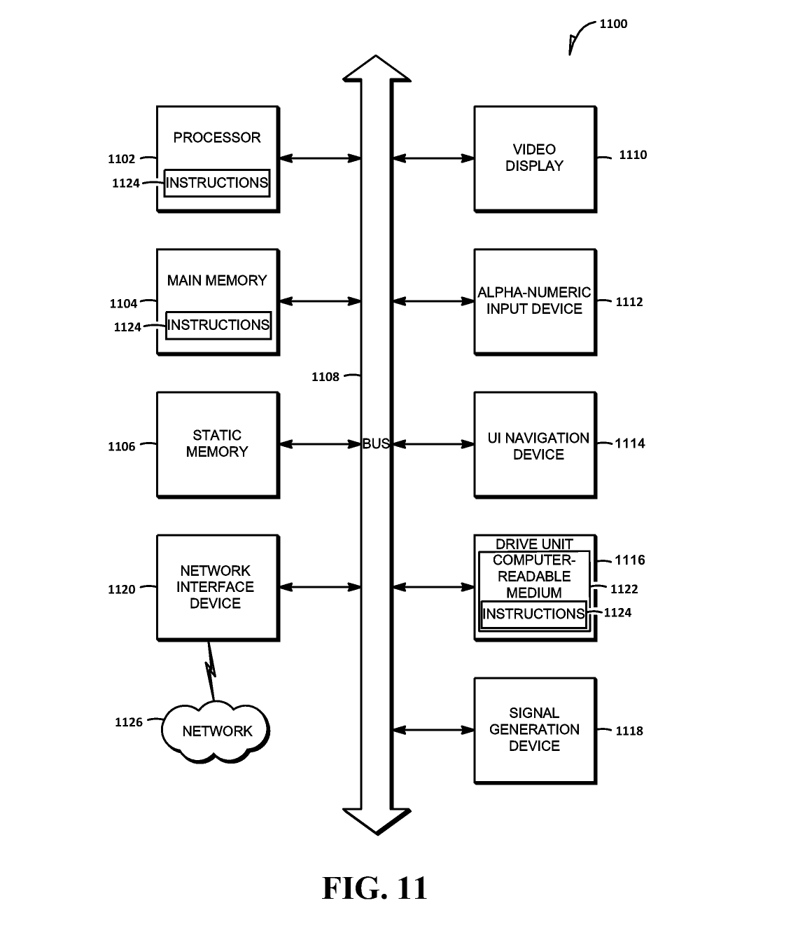

FIG. 11 shows a diagrammatic representation of machine in the example form of a computer system 1100 within which a set of instructions may be executed causing the machine to perform any one or more of the methodologies discussed herein. In alternative embodiments, the machine operates as a standalone device or may be connected (eg., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation device 1114 (e.g., a mouse), a disk drive unit 1116, a signal generation device 1118 (e.g., a speaker) and a network interface device 1120.

The disk drive unit 1116 includes a machine-readable medium 1122 on which is stored one or more sets of instructions and data structures (e.g., software 1124) embodying or utilized by any one or more of the methodologies or functions described herein. The software 1124 may also reside, completely or at least partially, within the main memory 1104 and/or within the processor 1102 during execution thereof by the computer system 1100, the main memory 1104 and the processor 1102 also constituting machine-readable media.

The software 1124 may further be transmitted or received over a network 1126 via the network interface device 1120 utilizing any one of a number of well-known transfer protocols (e.g., HTTP).

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
at least one processor having:
a trusted shipping service provider module configured to receive a selection of one or more shipping service providers approved by a recipient; and
a token generator configured to generate one or more tokens corresponding to a mailing address of the recipient and communicate the one or more tokens with the corresponding mailing address of the recipient to the selected shipping service providers, the one or more tokens valid only for the selected one or more shipping service providers.

2. The system of claim 1, wherein the token generator is configured to receive a request from a sender for a token associated with the recipient, and to communicate the one or more tokens corresponding to the mailing address of the recipient to the sender in response to the request, the one or more tokens comprising a code for the mailing address of the recipient.

3. The system of claim 2, wherein the token generator is configured to identify at least one of the selected shipping service providers to the sender, and to communicate to the sender that the one or more tokens are valid only with respect to the at least one of the selected shipping service providers.

4. The system of claim 1, wherein the token generator is configured to receive a query from a sender to confirm whether a shipping service provider has been approved by the recipient, and to communicate to the sender whether the shipping service provider has been approved by the recipient.

5. The system of claim 1, wherein the token generator is configured to receive a request from a sender for a token associated with the recipient and an identification of a shipping service provider, to determine whether the shipping service provider identified by the sender has been approved by the recipient, and to communicate a token associated with the identified shipping service provider to the sender based on the determination that the service provider identified by the sender has been approved by the recipient.

6. The system of claim 1, further comprising a storage device configured to store information of the sender, information of the recipient, a mailing address of the recipient, selected shipping service providers approved by the recipient, and the one or more tokens corresponding to the selected shipping service providers.

7. The system of claim 1, wherein the one or more tokens comprise an alphanumeric code corresponding to an identity of the recipient, the mailing address of the recipient, and a selected shipping service provider.

8. The system of claim 1, wherein the token generator associates the one or more tokens with the sender.

9. The system of claim 1, wherein the token generator generates a disposable token for a single use.

10. The system of claim 1, wherein the token generator generates the one or more token for a sender to apply the one or more token on a shipping package in lieu of a mailing address of the recipient.

11. The system of claim 1, wherein the processor further comprises:
a physical address validation module configured to retrieve and validate a physical address associated with an e-mail address received from a third party server;
a financial transaction validation module configured to retrieve a financial account associated with the e-mail address and operate a financial transaction on the financial account; and
a third party authentication module configured to authenticate the third-party server, from which the e-mail address was received, prior to operating the financial transaction.

12. A computer-implemented method comprising:
receiving a selection of one or more shipping service providers approved by a recipient;
generating one or more tokens corresponding to a mailing address of the recipient, the one or more tokens valid only for the selected one or more shipping service providers;
communicating the one or more tokens with the corresponding mailing address of the recipient to the selected shipping service providers.

13. The computer-implemented method of claim 12, further comprising:
receiving a request from a sender for a token associated with the recipient; and
communicating the one or more tokens corresponding to the mailing address of the recipient to the sender in response to the request, the one or more tokens comprising a code for the mailing address of the recipient.

14. The computer-implemented method of claim 13, further comprising:
identifying at least one of the selected shipping service providers to the sender; and
communicating to the sender that the one or more tokens are valid only with respect to the at least one of the selected shipping service providers.

15. The computer-implemented method of claim 12, further comprising:
receiving a query from a sender to confirm whether a shipping service provider has been approved by the recipient; and
communicating to the sender whether the shipping service provider has been approved by the recipient.

16. The computer-implemented method of claim 12, further comprising:
receiving a request from a sender for a token associated with the recipient and an identification of a shipping service provider;
determining whether the shipping service provider identified by the sender has been approved by the recipient; and
communicating a token associated with the identified shipping service provider to the sender based on the determination that the service provider identified by the sender has been approved by the recipient.

17. The computer-implemented method of claim 12, further comprising:
storing in a storage device, information of the sender, information of the recipient, a mailing address of the recipient, selected shipping service providers approved by the recipient, and the one or more tokens corresponding to the selected shipping service providers.

18. The computer-implemented method of claim 12, further comprising:
generating a single use disposable token associated with the sender.

19. The computer-implemented method of claim 12, further comprising:
generating the one or more token for a sender to apply the one or more token on a shipping package in lieu of a mailing address of the recipient.

20. A non-transitory computer-readable storage medium storing a set of instructions that, when executed by a processor, cause the processor to perform operations comprising:
receiving a selection of one or more shipping service providers approved by a recipient;
generating one or more tokens corresponding to a mailing address of the recipient, the one or more tokens valid only for the selected one or more shipping service providers;
communicating the one or more tokens with the corresponding mailing address of the recipient to the selected shipping service providers.
